(19) United States
(12) Patent Application Publication
(10) Pub. No.: US 2026/0265942 A1
(43) Pub. Date: Sep. 10, 2026

(54) AN ALTITUDE INSENSITIVE HIGH VOLTAGE INSULATION FOR POWER TRAIN IN AN ELECTRIFIED AIRCRAFT

(71) Applicants: Weijun YIN, Niskayuna, NY (US); Oltea p. SICLOVAN, Niskayuna, NY (US); James Duvall BOLLACKER, Niskayuna, NY (US); Muhammad SALIM, Clifton Park, NY (US); General Electric Company, Evendale, OH (US)

(72) Inventors: Weijun Yin, Niskayuna, NY (US); Oltea P. Siclovan, Rexford, NY (US); James Duvall Bollacker, Scotia, NY (US); Muhammad Salim, Clifton Park, NY (US)

(21) Appl. No.: 19/477,191

(22) PCT Filed: Jul. 22, 2024
(86) PCT No.: PCT/US2024/038991

§ 371 Date: Oct. 21, 2025

Related U.S. Application Data
(60) Provisional application No. 63/514,842, filed on Jul. 21, 2023.

(51) Int. Cl. C25D 13/02; C09D 7/61; C25D 13/16; H01B 1/02; H01B 3/30; H01B 19/04

(52) U.S. Cl. CPC C25D 13/02; C09D 7/61; C25D 13/16; H01B 1/02; H01B 3/30; H01B 19/04

(57) ABSTRACT

An altitude insensitive composite coating includes a polymer resin and a plurality of ceramic particles in an electrophoretically formed layer. A fraction of the plurality of ceramic particles in the composite coating is at least 40% by volume. A dielectric strength of the composite coating is at least 30 kilovolts per millimeter (kV/mm) at an air pressure corresponding to high altitude.

### CROSS-REFERENCE TO RELATED APPLICATIONS

This application claims priority to U.S. Provisional Application No. 63/514,842, filed on Jul. 21, 2023, and to International Application PCT/US2024/038991, filed Jul. 22, 2024, which are incorporated by reference in their entirety.

### FIELD

The present disclosure relates to composite coatings, particularly with ceramic particles and polymer resins.

### BACKGROUND

A gas turbine engine generally includes a turbomachine and a rotor assembly. Gas turbine engines, such as turbofan engines, may be used for aircraft propulsion. In the case of a turbofan engine, the rotor assembly may be configured as a fan assembly. Electrically insulated conductors known in the art can be degraded through electrical discharges, which are much less avoidable in high voltage applications, especially at high altitude.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of an exemplary aircraft.

FIG. 2 is a schematic view of an altitude insensitive component for the aircraft of FIG. 1 with a composite coating.

FIG. 3 is a schematic view of an electrophoretic process to form the composite coating of FIG. 2.

FIG. 4 is a magnified view of ceramic particles applied in the electrophoretic process of FIG. 3.

FIG. 5 is a chart illustrating a breakdown voltage for the composite coating of FIG. 2 compared to a thickness of the composite coating of FIG. 2.

FIG. 6 is a chart illustrating a partial discharge inception voltage for the composite coating of FIG. 2.

FIG. 7 is a block diagram of an exemplary method for forming the altitude insensitive component of FIG. 2.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

A high voltage electrical insulation material is considered “altitude insensitive” when its dielectric performance does not degrade at high altitude. This high altitude can be defined as an altitude from 30 thousand feet (kft) up to 45 kft above sea level. “Sea level” is a suitable fixed datum, such as Mean Sea Level as reported by the World Geodetic System.

A “breakdown voltage” is a voltage at which an electric discharge (such as an electric arc) forms between two electrodes.

The present disclosure is generally related to high voltage electrical insulation material for use at high altitude. Typically, a dielectric strength of an insulator decreases as air pressure decreases, such as at increasing altitudes in an aircraft, as described by Paschen's Law. As the dielectric strength decreases, a breakdown voltage of the insulator decreases. Defects in the insulator cause ionization and degradation at these high altitudes, particularly if the insulator is a polymer. Accordingly, insulation materials for electric components used in high altitude environments may be thicker than for components used at sea level.

A composite material with ceramic particles in a polymer matrix maintains its dielectric strength at high altitudes. In particular, when the composite material includes at least 40% ceramic particles by volume, the dielectric strength remains above 30 kilovolts per millimeter (kV/mm) at flight altitude for the aircraft. Because the ceramic particles do not degrade by ionization, the low pressure environment at high altitude does not significantly degrade the composite material. A coating for an electric component made with the composite material can be applied at lower thicknesses than a polymer insulator while maintaining the dielectric strength to insulate the electric component, improving the breakdown voltage of the electric component. Such an altitude insensitive composite coating forms an altitude insensitive electrical component.

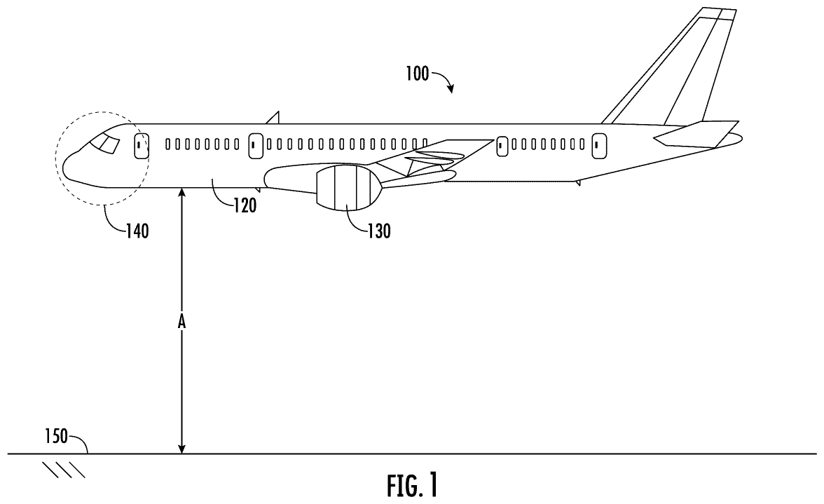

Referring now to the drawings, wherein identical numerals indicate the same elements throughout the figures, FIG. 1 depicts an aircraft 100 according to example embodiments of the present disclosure. As shown, the aircraft 100 can include a fuselage 120, one or more engines 130, and a cockpit 140. The aircraft 100 operates at an altitude A above a reference datum 150, such as sea level or the ground.

The aircraft 100 includes one or more electrical components, such as electric machines including windings, busbars, magnetic cores, casing, end rings, and other conductors. Insulation protects the electric components from causing electrical discharges, particularly at high altitude, low pressure environments. In particular, when the aircraft 100 includes a hybrid-electric gas turbine engine, thin coatings of electrical insulation prevent the electrical discharges while reducing weight and space in the aircraft 100, forming an altitude insensitive electrical component with the electrical insulation.

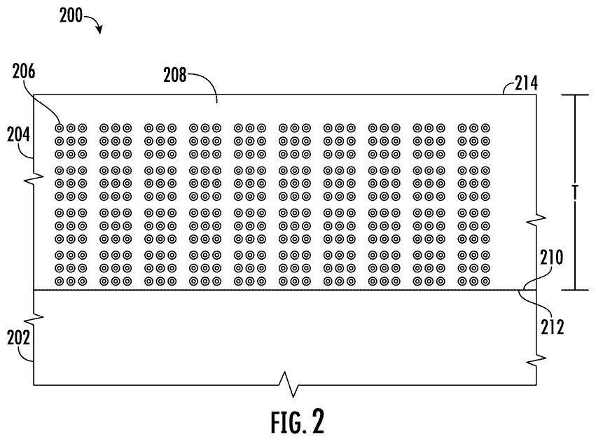

Now referring to FIG. 2, an exemplary altitude insensitive component 200 is shown. The altitude insensitive component 200 includes a conductor 202 and an altitude insensitive composite coating 204. The conductor 202 is an electrically conductive material, such as pure copper, nickel-cladded copper, or a copper alloy. The conductor 202 may be a wire (such as a winding for an electric machine), a bar (such as a busbar), a structure (such as a casing or an end ring), or any other electrically conductive part. That is, the conductor 202 is shielded from electrical discharge, either to allow transfer of electric current therethrough (such as in a wire) or to prevent electrical current to unintended parts (such as in a casing).

The composite coating 204 electrically insulates the conductor 202. The coating 204 includes a plurality of ceramic particles 206 and a polymer resin 208. The ceramic particles 206 provide dielectric strength that is substantially insensitive to altitude or pressure changes, which is suitable for use in the aircraft 100. The ceramic particles 206 can be metal oxides, metal nitrides, or other insulating materials, such as AlN, BN, Al2O3, SiO2, TiO2, MgO, Cr2O3, Mica, or combinations thereof. In the exemplary component 200 of FIG. 2, the ceramic particles 206 are aluminum nitride (AlN). The ceramic particles 206 have diameters in a distribution on the order of microns, such as from 0.50 to 5.00 microns. As an example, the ceramic particles 206 may have a D10 from 0.50 to 2.50 microns, a D50 from 2.00 to 3.50 microns, and a D90 from 3.50 to 5.00 microns.

The polymer resin 208 binds the ceramic particles 206 together to form the composite coating 204. The polymer resin 208 is a material that binds and provides structural reinforcement to the ceramic particles 206 to form the composite coating 204. The polymer resin 208 may be a thermoset or thermal plastic material, such as silicone, epoxy, polyurethane, polyester, polyimide, polyesterimide, polyamide, cyanate ester. In the exemplary component 200 of FIG. 2, the polymer resin 208 is a thermosetting methyl or phenyl silicone. The polymer resin 208 is applied to the ceramic particles 206 in a suitable resin infusion process, such as applying a vacuum and curing under a specified pressure. Together, the polymer resin 208 and the ceramic particles 206 form the altitude insensitive composite coating 204.

The composite coating 204 has a thickness T defined from an inner surface 210 that contacts an outer surface 212 of the conductor 202 to an outer surface 214. The thickness T may be determined for specific properties, such as thermal protection of the conductor 202, tensile strength of the composite coating 204, among others. The thickness T may be from 100 microns to 600 microns, and the composite coating 204 of the exemplary component 200 of FIG. 2 has a thickness T from 200 to 300 microns.

The volume of ceramic particles 206 relative to the volume of the polymer resin 208 may be determined based on the specific dielectric strength specified for the component 200. That is, as the volume of ceramic particles 206 increases, the dielectric strength of the composite coating 204 improves, particularly at air pressures corresponding to high altitudes. In particular, when a fraction of the plurality of ceramic particles 206 in the composite coating 204 is at least 40% by volume, the composite coating 204 becomes altitude insensitive. The fraction of the plurality of ceramic particles 206 may be increased to a limit at which the polymer resin 208 is capable of binding the ceramic particles 206 together. As an example, the fraction of the plurality of ceramic particles 206 in the composite coating 204 may be from 40%-80% by volume (such as from 50%-60% by volume), and the remaining volume is the polymer resin 208.

Below is one example of the composition of the composite coating 204:

| Material | Volume (%) | Weight (%) | Volume (cm³) | Weight (g) |
|---|---|---|---|---|
| AlN | 55 | 179.3 | 1.524 | 150.28926 |
| Resin | 45 | 48.6 | 1.524 | 33.32988 |

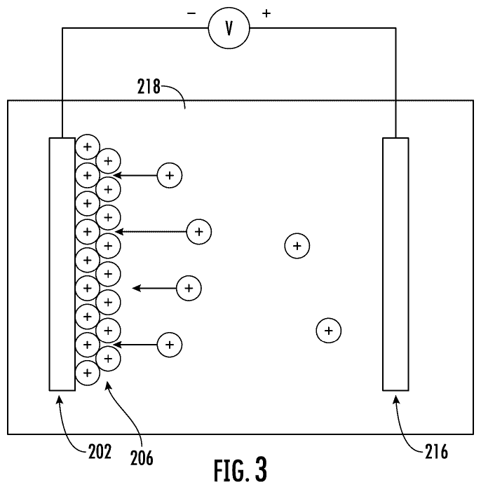

Now referring to FIG. 3, a process for applying the ceramic particles 206 to the conductor 202 is shown. More specifically, the ceramic particles 206 are formed in a layer in an electrophoretic deposition (EPD) process. In EPD, an anode 216 and a cathode (here, the conductor 202) are placed in a slurry 218 containing a positively-charged material (here, the ceramic particles 206) and a voltage is applied to the anode 216 and the cathode, causing the cathode to gain a negative charge. The positively-charged material is attracted to and adheres to the negatively-charged cathode in a layer. Specifically, the slurry 218 in FIG. 3 includes the ceramic particles 206 and a dispersant, such as polyethyleneimine. Upon applying the voltage across the anode 216 and the conductor 202 in the slurry 218, the positively-charged ceramic particles 206 form a layer on the negatively-charged conductor 202. That is, the ceramic particles 206 are formed in an electrophoretically formed layer on the conductor 202.

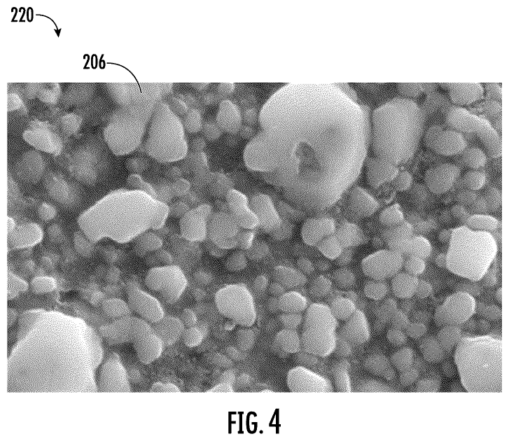

With reference to FIG. 4, a magnified view of a layer 220 of ceramic particles 206 is shown. During EPD, the ceramic particles 206 are arranged such that defects in the layer 220 are small, such as below 1.0 micron. Such small defects inhibit ionization and breakdown of the layer 220 at low pressures (such as at high altitude), and electrical properties of the layer 220 become altitude insensitive. EPD thus provides a suitable layer 220 of ceramic particles 206 for use in the component 200 (FIG. 2) at high altitudes.

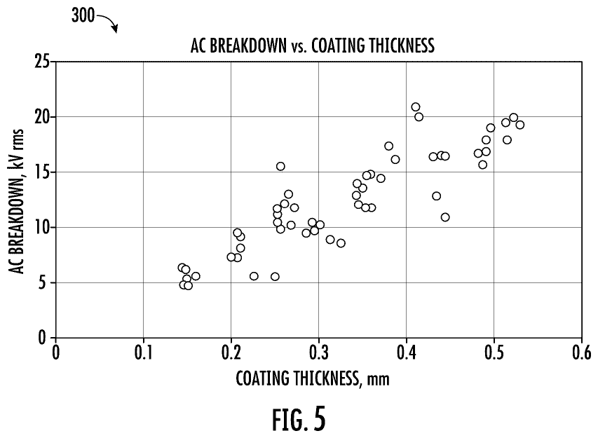

Now referring to FIG. 5, a chart 300 illustrating a breakdown voltage of test composite coatings 204 for the component 200 (FIG. 2) correlated to a thickness Tis shown. The breakdown voltage is a metric indicating a dielectric strength of the composite coating 204. In the chart 300, the vertical axis is the breakdown voltage (listed here as “AC breakdown”), measured in kV root-mean-square (rms). The horizontal axis is the thickness T of the test composite coating 204, measured in millimeters. It will be appreciated that the thickness T of the composite coating 204 may be listed in either millimeters or microns, where the specific measurement is the same and the scale only differs for clarity of the disclosure. The dielectric strength can be determined by dividing the breakdown voltage (in kV) by the coating thickness (in mm).

The specified dielectric performance needs can be met by tuning the thickness T of the composite coating 204. Dielectric strengths of at least 30 kV/mm have been achieved consistently when the thickness T is in a range from 150 microns to 550 microns (0.15 mm to 0.55 mm), as shown in the chart 300. As an example, for a coating 204 with a thickness T of around 150 microns, the breakdown voltage ranges from 4.7 to 6.2 kV rms, and the dielectric strength thus ranges from 31.3 kV/mm to 41.3 kV/mm. It will be appreciated that the thickness T of the composite coating 204 may be smaller than thicknesses of other insulators while maintaining similar dielectric properties.

As shown in Table 1 below, the breakdown voltage was found to be stable with increasing altitude. For wires with coating thickness between 400 and 500 microns, the breakdown voltages are greater than 10 kV rms (11 to 19 kV rms), and a true breakdown value cannot be measured at 40 kft at voltage as high as 10.8 kV rms due to flashover. This flashover indicates that the true breakdown voltages could be as high as those measured at sea level. Accordingly, the breakdown voltages of the composite coatings 204 indicate that the composite coatings 204 are altitude insensitive up to 40 kft. In general, the breakdown voltage of each composite coating 204 was at least 6.7 kV rms, typically at least 7.0 kV rms. Accordingly, the composite coating 204 renders the component 200 altitude insensitive at high altitudes.

TABLE 1
Altitude impact on AC breakdown voltage of EPD insulation

| | | | | Breakdown Voltage, | | | |
|---|---|---|---|---|---|---|---|
| Sample | Coating thickness (mm) | | | sea level (kV rms) | | | kV/mm |
| 1 | 0.444 | 0.434 | 0.443 | 10.85 | 12.78 | 16.41 | 30.31 |
| 2 | 0.434 | 0.414 | 0.430 | 16.37 | 19.93 | 16.23 | 40.93 |
| | | | | Breakdown Voltage, | | | |
| | | | | 40 kft (kV rms) | | | |
| 3 | | | | 10 | flashover | | |
| 4 | | | | 10.8 | flashover | | |
| 5 | | | | 607 | flashover | | |

| | | | | Breakdown Voltage, | | | |
|---|---|---|---|---|---|---|---|
| | Coating thickness (mm) | | | sea level (kV rms) | | | kV/mm |
| 1 | 0.496 | 0.515 | 0.486 | 18.88 | 17.81 | 15.62 | 34.95 |
| 2 | 0.482 | 0.490 | 0.490 | 16.60 | 17.79 | 16.78 | 35.02 |
| | | | | Breakdown Voltage, | | | |
| | | | | 40 kft (kV rms) | | | |
| 3 | | | | 9.8 | flashover | | |
| 4 | | | | 10.6 | flashover | | |
| 5 | | | | 7.9 | flashover | | |
| 1 | 0.146 | 0.148 | 0.144 | 4.70 | 5.28 | 6.29 | 37.10 |
| 2 | 0.150 | 0.160 | 0.178 | 4.73 | 5.57 | 6.16 | |
| | | | | Breakdown Voltage, | | | |
| | | | | 40 kft (kV rms) | | | |
| 3 | | | | 6.29 | failure | | |
| 4 | | | | 4.95 | failure | | |
| 5 | | | | 6.39 | failure | | |

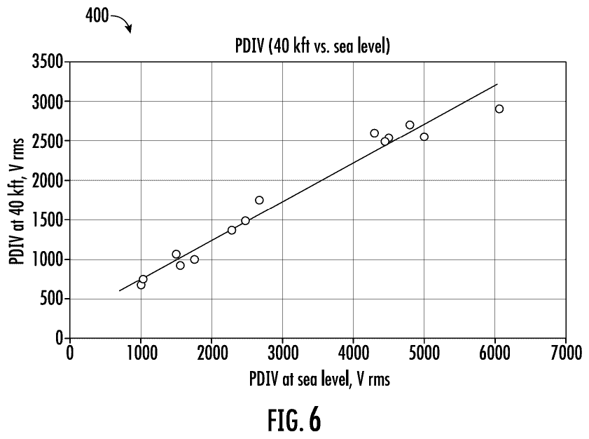

Now referring to FIG. 6, a chart 400 is shown illustrating a partial discharge inception voltage (PDIV) of the composite coating 204 at an air pressure corresponding to high altitude and a PDIV of the composite coating 204 at an air pressure corresponding to sea level. The vertical axis shows a measured PDIV of a sample component 200 at an air pressure corresponding to 40 kft in volts (V) rms. The horizontal axis shows a measured PDIV of the sample component 200 at an air pressure corresponding to sea level in V rms. Each point is a sample component 200 with a composite coating 204 at a specific thickness T.

As shown in the chart 400, PDIV values for each component 200 at high altitude are about 42% lower than the corresponding PDIV values at sea level. This is a smaller drop than a conventional insulated component (such as a polyimide coated wire), where the PDIV values at high altitude are typically 60-80% lower than those at sea level. Thus, the PDIV for the component 200 at air pressure corresponding to high altitude is at least 50% of the PDIV of the component 200 at air pressure corresponding to sea level, an improvement over conventional insulated components.

In addition to improved PDIV performance, the component 200 with the composite coating 204 has improved voltage endurance (VE). A group of nine wires were tested under sinusoidal voltages of 60 Hz at air pressure corresponding to 40 kft following multiple steps. The wires were first subjected to 2.8 kV for 96 hours, then tested for PDIV. Afterwards the wires were put back for additional 110 hrs at 2.8 kV, followed by a partial discharge (PD) test. The wires were then returned to test at 3 kV for 100 hrs, removed for another PD test, and subsequently test at 3.2 kV for 244 hrs and removed for further PD tests. The wires went through a total of 550 hours of testing without failure. The PDIV and partial discharge extinction voltage (PDEV) for each of the wires were compared before and after each step.

Table 2 lists the thickness T of the composite coating 204 and measured PDIV and PDEV values at 40 kft before and after the VE tests. No clear trends were observed in PDIV and PDEV values after the VE tests, with some showing increases in PDIV and others showing decreases in PDIV. PDEV was measured to be about 10-15% lower than PDIV. The VE results indicate that components 200 with the composite coating 204 have improved partial discharge resistance suitable for high altitude environments.

TABLE 2
PDIV at 40 kft before and after VE tests

| | Wire | Insulation | | |
|---|---|---|---|---|
| | Diameter | thickness | Prior to VE | |
| Sample | (mm) | (mm) | PDIV (kV) | PDEV (kV) |
| 1 | 1.98 | 0.38 | 1.00 | 0.95 |
| 2 | 1.98 | 0.29 | 1.00 | 0.97 |
| 3 | 1.98 | 0.32 | 0.97 | 0.91 |
| 4 | 1.98 | 0.35 | 1.15 | 1.05 |
| 5 | 1.98 | 0.33 | 1.12 | 1.03 |
| 6 | 1.98 | 0.31 | 1.06 | 0.96 |
| 7 | 1.98 | 0.37 | 1.18 | 1.03 |
| 8 | 1.98 | 0.42 | 1.10 | 0.87 |
| 9 | 1.98 | 0.43 | 0.98 | 0.87 |

| Sample | After 1^{st} VE | | After 2^{nd} VE | | After 3^{rd} VE | | After 4^{th} VE | |
|---|---|---|---|---|---|---|---|---|
| 1 | >3.00 | — | 2.60 | 2.45 | 2.39 | 2.26 | >3.00 | — |
| 2 | 2.18 | 2.05 | 2.90 | 2.85 | 2.50 | 2.30 | >3.00 | — |
| 3 | 2.60 | 2.50 | 1.40 | 1.25 | 0.98 | 0.92 | 0.85 | 0.80 |
| 4 | >3.00 | — | 1.00 | 0.87 | 1.05 | 0.95 | 0.74 | 0.60 |
| 5 | 2.85 | 2.75 | 2.60 | 2.50 | 1.10 | 0.98 | 0.86 | 0.75 |
| 6 | 2.36 | 2.05 | 2.55 | 2.25 | 1.03 | 0.98 | 0.92 | 0.84 |
| 7 | 1.75 | 1.65 | 1.10 | 1.02 | 0.97 | 0.80 | 0.86 | 0.75 |
| 8 | 2.30 | 2.18 | 1.50 | 1.30 | 1.03 | 0.97 | 1.10 | 1.05 |
| 9 | >3.00 | — | 2.15 | 2.10 | >3.00 | — | 2.90 | 2.70 |

In addition to electrical properties, the composite coating 204 improves thermal properties of the component 200. Five copper wires with the composite coating 204 were placed in an oven at 300° C. for 250 hours. The composite coating 204 passed a high potential (hipot) test at 2.5 kV rms, indicating that the component 200 maintains electric performance even after exposure to high temperatures.

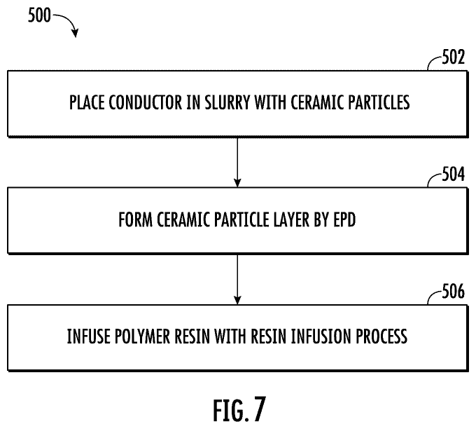

Referring now to FIG. 7, a flow diagram of a method 500 of forming a component with a composite coating is provided. The method 500 may be utilized to form the component 200 with the composite coating 204 described with reference to FIGS. 2-6.

As is depicted, the method 500 includes at (502) placing a conductor in a slurry with a plurality of ceramic particles. As described above and shown in FIG. 3, at an initiation of an EPD process, the conductor is placed into a slurry that includes the ceramic particles. The slurry may include an additive such as a dispersant or charging agent. As a non-limiting example, the additive may be polyion such as polyethyleneimine or polyacrylic acid.

The method 500 includes at (504) forming a layer of the ceramic particles on the conductor. More specifically, in the EPD process, a voltage is applied to an anode and the conductor to cause the conductor to have a negative charge. The ceramic particles, which are positively charged, move onto the conductor to form a layer, such as is shown in FIG. 4.

The method 500 includes at (506) infusing a polymer resin to the layer of the ceramic particles in a resin infusion process. The resin infusion process includes at least one of applying a vacuum, curing under pressure, or both. By infusing the layer with the polymer resin, an altitude insensitive composite coating is formed. More specifically, the ceramic particles in the composite coating have a dielectric strength that is at least 30 kV/mm at an air pressure corresponding to high altitude, and thus the component formed with the composite coating has a dielectric strength that is altitude insensitive.

The altitude insensitive composite coating allows for a component that maintains electrical properties at high altitude environments. More specifically, by applying ceramic particles to a conductor in an EPD process, the dielectric strength of the component remains high at the low air pressures in high altitude conditions with less degradation than a conventional coating. The polymer resin binds the ceramic particles together, allows for thermal and mechanical protection of the conductor. In such a form, the composite coating forms an altitude insensitive component useful for aviation.

Further aspects are provided by the subject matter of the following clauses:

An altitude insensitive composite coating includes a polymer resin and a plurality of ceramic particles in an electrophoretically formed layer, wherein a fraction of the plurality of ceramic particles in the composite coating is at least 40% by volume, wherein a dielectric strength of the composite coating is at least 30 kilovolts per millimeter (kV/mm) at an air pressure corresponding to high altitude.

The composite coating of any of the preceding clauses, wherein the ceramic particles include AlN, BN, Al2O3, SiO2, TiO2, MgO, Cr2O3, Mica, or combinations thereof.

The composite coating of any of the preceding clauses, wherein the polymer resin includes silicone, epoxy, polyurethane, polyester, polyimide, polyesterimide, polyamide, cyanate ester, or combinations thereof.

The composite coating of any of the preceding clauses, wherein the resin is infused between the plurality of ceramic particles.

The composite coating of any of the preceding clauses, wherein a thickness of the composite coating is from 100 microns to 600 microns.

The composite coating of any of the preceding clauses, wherein a breakdown voltage of the composite coating at the air pressure corresponding to high altitude is at least 7.0 kV root-mean-square (rms).

The composite coating of any of the preceding clauses, wherein the fraction of the plurality of ceramic particles is from 50-60% by volume.

The composite coating of any of the preceding clauses, wherein a measured partial discharge inception voltage of the composite coating at the air pressure corresponding to high altitude is at least 50% of a measured partial discharge inception voltage of the composite coating at an air pressure corresponding to sea level.

A method for forming an altitude insensitive component, the method including forming a layer a plurality of ceramic particles to a conductor in an electrophoretic deposition process and applying a polymer resin to the plurality of ceramic particles in a resin infusion process to form a composite coating on the conductor, wherein a fraction of the plurality of ceramic particles in the composite coating is at least 40% by volume, wherein a dielectric strength of the composite coating is at least 30 kilovolts per millimeter (kV/mm) at an air pressure corresponding to high altitude.

The method of any of the preceding clauses, wherein the ceramic particles include AlN, BN, Al2O3, SiO2, TiO2, MgO, Cr2O3, Mica, or combinations thereof.

The method of any of the preceding clauses, wherein the polymer resin includes silicone, epoxy, polyurethane, polyester, polyimide, polyesterimide, polyamide, cyanate ester, or combinations thereof.

The method of any of the preceding clauses, wherein the resin infusion process includes at least one of: applying a vacuum or curing the polymer resin under pressure.

The method of any of the preceding clauses, wherein a thickness of the composite coating is from 100 microns to 600 microns.

The method of any of the preceding clauses, wherein the fraction of the plurality of ceramic particles is from 50-60% by volume.

The method of any of the preceding clauses, further including applying placing the conductor in a slurry including the plurality of ceramic particles prior to performing the electrophoretic deposition process.

The method of any of the preceding clauses, wherein a measured partial discharge inception voltage of the composite coating at the air pressure corresponding to high altitude is at least 50% of a measured partial discharge inception voltage of the composite coating at an air pressure corresponding to sea level.

The method of any of the preceding clauses, wherein a breakdown voltage of the composite coating at the air pressure corresponding to high altitude is at least 7.0 kV root-mean-square (rms).

An altitude insensitive component formed according to the method of any of the preceding clauses.

The component of any of the preceding clauses, wherein the conductor is a wire.

The component of any of the preceding clauses, wherein the conductor is pure copper, nickel-cladded copper, or a copper alloy.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An altitude insensitive composite coating comprising:
a polymer resin; and
a plurality of ceramic particles in an electrophoretically formed layer,
wherein a fraction of the plurality of ceramic particles in the composite coating is at least 40% by volume,
wherein a dielectric strength of the composite coating is at least 30 kilovolts per millimeter (kV/mm) at an air pressure corresponding to high altitude.

2. The composite coating of claim 1, wherein the ceramic particles include AlN, BN, Al2O3, SiO2, TiO2, MgO, Cr2O3, Mica, or combinations thereof.

3. The composite coating of claim 1, wherein the polymer resin includes silicone, epoxy, polyurethane, polyester, polyimide, polyesterimide, polyamide, cyanate ester, or combinations thereof.

4. The composite coating of claim 1, wherein the resin is infused between the plurality of ceramic particles.

5. The composite coating of claim 1, wherein a thickness of the composite coating is from 100 microns to 600 microns.

6. The composite coating of claim 1, wherein a breakdown voltage of the composite coating at the air pressure corresponding to high altitude is at least 7.0 kV root-mean-square (rms).

7. The composite coating of claim 1, wherein the fraction of the plurality of ceramic particles is from 50-60% by volume.

8. The composite coating of claim 1, wherein a measured partial discharge inception voltage of the composite coating at the air pressure corresponding to high altitude is at least 50% of a measured partial discharge inception voltage of the composite coating at an air pressure corresponding to sea level.

9. A method for forming an altitude insensitive component, the method comprising:
forming a layer a plurality of ceramic particles to a conductor in an electrophoretic deposition process; and
applying a polymer resin to the plurality of ceramic particles in a resin infusion process to form a composite coating on the conductor,
wherein a fraction of the plurality of ceramic particles in the composite coating is at least 40% by volume,
wherein a dielectric strength of the composite coating is at least 30 kilovolts per millimeter (kV/mm) at an air pressure corresponding to high altitude.

10. The method of claim 9, wherein the ceramic particles include AlN, BN, Al2O3, SiO2, TiO2, MgO, Cr2O3, Mica, or combinations thereof.

11. The method of claim 9, wherein the polymer resin includes silicone, epoxy, polyurethane, polyester, polyimide, polyesterimide, polyamide, cyanate ester, or combinations thereof.

12. The method of claim 9, wherein the resin infusion process includes at least one of:
applying a vacuum; or
curing the polymer resin under pressure.

13. The method of claim 9, wherein a thickness of the composite coating is from 100 microns to 600 microns.

14. The method of claim 9, wherein the fraction of the plurality of ceramic particles is from 50-60% by volume.

15. The method of claim 9, further comprising applying placing the conductor in a slurry including the plurality of ceramic particles prior to performing the electrophoretic deposition process.

16. The method of claim 9, wherein a measured partial discharge inception voltage of the composite coating at the air pressure corresponding to high altitude is at least 50% of a measured partial discharge inception voltage of the composite coating at an air pressure corresponding to sea level.

17. The method of claim 9, wherein a breakdown voltage of the composite coating at the air pressure corresponding to high altitude is at least 7.0 kV root-mean-square (rms).

18. An altitude insensitive component formed according to the method of claim 9.

19. The component of claim 18, wherein the conductor is a wire.

20. The component of claim 18, wherein the conductor is pure copper, nickel-cladded copper, or a copper alloy.
